(19) United States
(12) Patent Application Publication
(10) Pub. No.: US 2007/0084678 A1
(43) Pub. Date: Apr. 19, 2007

(54) Device for initiating and implementing a sudden vehicle deceleration

(76) Inventors: Bernhard Lucas, Besigheim (DE); Martin Heinebrodt, Stuttgart (DE); Martin Staempfle, Schwieberdingen (DE); Wolfgang Branz, Stuttgart (DE)

Correspondence Address: KENYON & KENYON LLP, ONE BROADWAY, NEW YORK, NY, 10004, US

(21) Appl. No.: 10/565,467

(22) PCT Filed: Jul. 10, 2004
(86) PCT No.: PCT/DE04/01506

§ 371 Date: Jan. 19, 2006

(30) Foreign Application Priority Data
Jul. 22, 2003 (DE) 103 33 462.9

(51) Int. Cl. F16D 55/08

(52) U.S. Cl. 188/72.1

(57) ABSTRACT

A device for initiating and implementing a sudden vehicle deceleration, especially for emergency braking situations, the deceleration being initiated by the explosion of at least one propelling charge or explosive charge that acts on at least one component of the deceleration devices. Due to the explosion of the propelling charge or explosive charge, a piston is moved that applies pressure to the brake fluid, or an arrester is destroyed so that the stored energy of an energy-storing apparatus can be released. This device is triggered automatically with the aid of a surrounding-field sensor system when an unavoidable collision is detected based upon the objects in the surroundings of the vehicle and their movement.

### FIELD OF THE INVENTION

The present invention relates to a device for initiating and implementing a sudden vehicle deceleration, especially for emergency braking situations, the deceleration being initiated by the explosion of at least one propelling charge or explosive charge that acts upon at least one component of the deceleration devices. Due to the explosion of the propelling charge or explosive charge, a piston is moved that applies pressure to the brake fluid, or an arrester is destroyed so that the stored energy of an energy-storing apparatus can be released. This device is triggered automatically with the aid of a surrounding-field sensor system when an unavoidable collision is detected on the basis of objects in the surroundings of the vehicle and their movement.

### BACKGROUND INFORMATION

International Patent Application No. WO 03/006291 A1 describes a method and a device for triggering and implementing a deceleration of a vehicle to avoid a collision. In that case, objects in the sensor sensing range are detected by a device for the distance and speed control of the vehicle, and measured quantities are ascertained for each detected object; the detected objects are assigned to different object classes based on the ascertained, associated measured quantities; and the movement trajectories of the objects are predicted on the basis of the assignment of the detected objects to the respective class. From these predicted movement trajectories of the objects and the associated detected object classes, additionally a collision risk is ascertained and if a specifiable collision risk exists, the deceleration devices of the vehicle are triggered as a function of the degree of the collision risk.

### SUMMARY

In accordance with an example embodiment of the present invention, in response to a driving situation in which it has been recognized that an unavoidable collision is imminent, an emergency braking by a sudden vehicle deceleration is implemented that is as strong as possible. This emergency braking is intended to avoid the collision or to reduce the impact strength of the vehicle as sharply as possible. For that purpose, partially irreversible deceleration devices are described by which the vehicle is to be braked as strongly as possible.

Advantageously, the firing of a propelling charge or explosive charge is provided for triggering the sudden vehicle deceleration or emergency braking, by which great energy can be released very rapidly and a strong decelerative effect can be achieved. Conventionally, the use of propelling charges or explosive charges in dangerous situations is used in airbags in motor vehicles, for example, and has been adequately tested.

The explosion of the propelling charge or explosive charge advantageously moves a piston that applies pressure to the brake fluid. Owing to the rapid movement of the piston as a result of the propelling/explosive charge effect, a high brake-fluid pressure is available very quickly which is independent of the pumping capacity of any existing brake-fluid pump.

Moreover, it is advantageous if an arrester is destroyed by the explosion, so that an energy-storing apparatus is able to release the stored energy very quickly, and a high application pressure of the brake pistons or brake linings on the brake disks is thereby achieved.

It is further advantageous if the energy-storing apparatus is a fluid reservoir under high pressure which causes a pressure build-up in the brake system due to the destruction of the arrester. In this context, the pressurized brake fluid reservoir may be under high pressure permanently, since the function of the present invention is needed only once, and after that a repair in an automotive garage is necessary.

It is also possible, however, to produce the high pressure of the additional brake fluid reservoir by a brake fluid pump that, for instance, after the vehicle is started, charges the pressure reservoir to the operating pressure and recharges it regularly during operation, so that the high pressure can be called for rapidly in case of need.

The energy-storing apparatus advantageously has a preloaded spring or a preloaded piston which builds up pressure in the brake system by tension release. In this connection, the spring may be embodied as a spiral spring, for example, or as a set of several disk springs.

Moreover, it is advantageous if the arrester is in the form of one or more retaining bolts or a valve which can be released or destroyed by the propelling charge or explosive charge, the arresting function thereby being neutralized and the energy-storing apparatus being able to release its stored energy for the decelerative action.

It is also advantageous if the at least one component of the deceleration devices on which the propelling charge or explosive charge acts is the master brake cylinder. This embodiment has the advantage that the master brake cylinder is already present in every vehicle, and is designed in such a way that the vehicle can be reliably decelerated by the brake pressure able to be built up with the master brake cylinder. The specific embodiment in which the at least one component of the deceleration devices on which the propelling charge or explosive charge acts is the master brake cylinder, is an especially preferable specific embodiment, since this implementation makes do with the smallest number of additionally needed parts.

It is also advantageous if the at least one component of the deceleration devices on which the propelling charge or explosive charge acts is an additional brake cylinder. In case of need, this additional brake cylinder supplies the necessary pressure to the hydraulic brake system and requires no redesign of the existing master brake cylinder.

It is also advantageous if the at least one component of the deceleration devices on which the propelling charge or explosive charge acts is an arrester in the brake caliper; in response to the explosion of the propelling charge or explosive charge, the arrester releases additional preloaded brake pistons that act on the brake disks. In this exemplary embodiment, it is necessary that in the brake calipers of the wheel brakes, additional brake pistons be provided which, in the event of an emergency braking, are released by an explosion of the propelling/explosive charge and are therefore independent of the master brake cylinder or the hydraulic system of the brake system.

It is furthermore advantageous that the firing of the propelling charge or explosive charge is triggered by a surrounding-field sensor system when an unavoidable collision is detected based on the objects in the surroundings of the vehicle and their movement. In this connection, a propelling charge or explosive charge may be fired.

Moreover, it is advantageous if the sensor system has a radar sensor for adaptive distance and speed measurement or a video sensor or a laser sensor or an ultrasonic sensor or a combination of these sensors, by which it is possible to detect objects in the surroundings of the vehicle, as well as their speed and moving direction.

It may be advantageously provided that after triggering the sudden vehicle deceleration, the pressure in the brake system is reducible by opening at least one valve of an antilock braking system. Nowadays, every new vehicle is equipped with an antilock braking system which, when the wheel has a tendency to lock, is able to lower the pressure of the brake system at the specific wheel cylinder by selectively controlled valve openings, in order to ensure the road grip of the vehicle wheel. By targeted opening of the valves of the antilock braking system of the individual wheels, it is also possible to influence the direction of movement of the suddenly and strongly decelerating vehicle, or to turn it so that an unavoidable crash of the vehicle happens in such a way that the risk of danger for the occupants is minimized.

It is further advantageous if the propelling charges or explosive charges are situated so that at least one wheel bearing of the vehicle is deformed by their explosion in such a way that, by deliberate destruction of the wheel bearing, a deceleration results, since the vehicle axle is prevented from further turning in the wheel bearing.

Additional features, applications and advantages of the present invention are derived from the following description of exemplary embodiments of the present invention, which are illustrated in the figures. In this context, all of the described or represented features, alone or in any combination, form the subject matter of the present invention, regardless of their wording and representation in the specification and in the drawing, respectively.

### BRIEF DESCRIPTION OF THE DRAWINGS

Exemplary embodiments of the present invention are explained below with reference to the figures.

FIG. 1 shows a first exemplary embodiment of the device according to the present invention, in which the propelling/explosive charge is situated in the master brake cylinder.

FIG. 2 shows another specific embodiment of the device according to the present invention, in which a further brake fluid reservoir is provided with propelling/explosive charge.

FIG. 3 shows another exemplary embodiment of the device according to the present invention, in which a further brake fluid reservoir is likewise provided.

FIG. 4 shows another exemplary embodiment of the device according to the present invention, which provides for a further brake fluid reservoir under high pressure.

FIG. 5 shows another exemplary embodiment of the device according to the present invention, in which no influence on the hydraulic components of the brake system is necessary.

FIG. 6 shows a further exemplary embodiment of the device according to the present invention.

### DETAILED DESCRIPTION OF EXAMPLE EMBODIMENTS

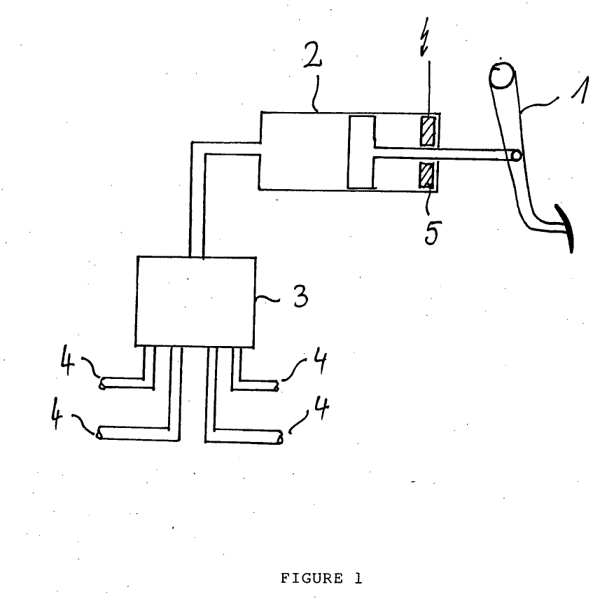

FIG. 1 shows an exemplary embodiment of the device according to the present invention. Brake pedal 1 can be seen, which acts upon a piston in master brake cylinder 2 upon actuation with the aid of a linkage. In so doing, pressure is applied to the brake fluid in master brake cylinder 2, so that the brake fluid pressure can be transmitted via a line system to the wheel pistons (not shown) of the wheel brakes, whose supply lines 4 are shown. Moreover, a hydraulic modulator 3 may be provided, as employed for the use of antilock braking systems. This hydraulic modulator 3 includes, e.g., an accumulator, a return pump and at least one solenoid valve. As long as the vehicle wheels exhibit no tendency to lock, this hydraulic modulator 3 behaves passively and allows the brake pressure to pass. Only if one or more wheels have the tendency to lock does hydraulic modulator 3 intervene in the hydraulic system of the vehicle and reduce the pressure in individual supply lines 4 to the wheel cylinders of the brake system. If, using the surrounding-field sensor system, it is determined that a collision is unavoidable, then a propelling charge or explosive charge 5 is fired, which is controllable via a firing line (flash). By detonating propelling or explosive charge 5, the master brake piston is shifted toward the brake fluid in master brake cylinder 2, resulting in a sudden pressure rise of the brake fluid. This pressure rise in the brake fluid is transmitted into the individual conduits, that is, supply lines 4 to the wheel pistons of the brake system, thereby achieving a sudden and sharp deceleration.

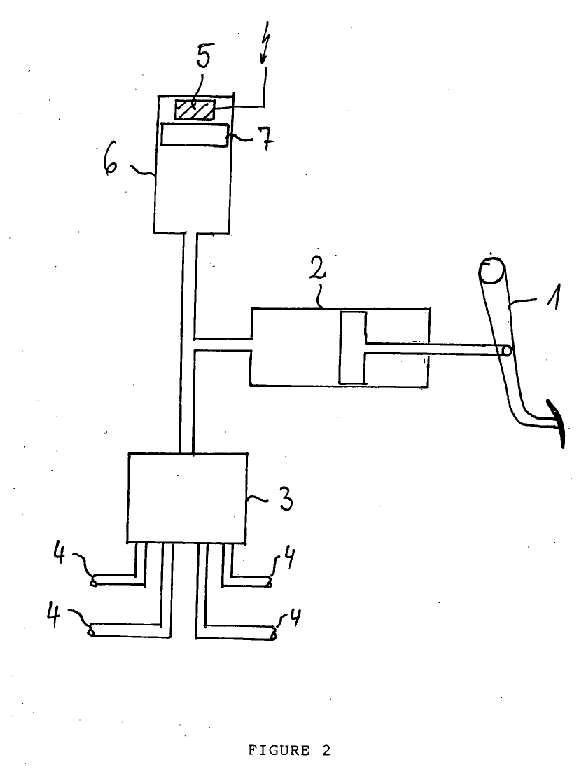

FIG. 2 likewise shows a schematic brake system actuated by brake pedal 1. Upon actuation of brake pedal 1, a piston in master brake cylinder 2 is displaced via a linkage, whereby a brake pressure is built up. This brake pressure is transmitted to the wheel brakes via wheel-piston supply lines 4, which are routed via a hydraulic modulator 3 that may optionally be provided. Moreover, an additional brake fluid reservoir 6 having a piston 7 is provided at the line which connects master brake cylinder 2 to hydraulic modulator 3. Behind piston 7, thus on the side facing away from the brake fluid, a propelling/explosive charge 5 is provided that is controllable via a firing line (flash). If an unavoidable collision is detected, the surrounding-field sensor system outputs a firing signal which causes propelling/explosive charge 5 to detonate, thereby displacing piston 7 toward the brake fluid in additional brake-fluid reservoir 6. In this way, a sudden rise in brake pressure results, which is transmitted via an optionally provided hydraulic modulator 3 to supply lines 4 leading to the wheel pistons of the brakes. In this exemplary embodiment, it may further be advantageous to provide a non-return valve at the output of master brake cylinder 2, so that the piston of master brake cylinder 2 is not pushed back and the brake pedal is not tilted abruptly into the footwell of the passenger compartment as a result of the explosion of propelling/explosive charge 5 that causes the brake pressure to rise abruptly.

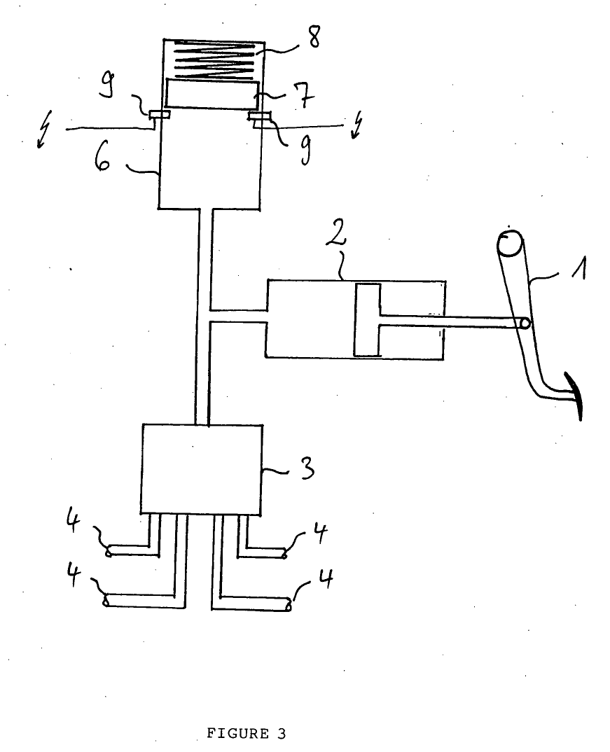

FIG. 3 also shows a device of the present invention, which generally corresponds to the device according to FIG. 2. Brake pedal 1 can again be seen, which is connected via a linkage to master brake cylinder 2. By actuating brake pedal 1, brake pressure can be built up in master brake cylinder 2, which transmits the brake pressure via a supply line and an optionally provided hydraulic modulator 3 to supply lines 4 to the wheel pistons of the brake system. An additional brake fluid reservoir 6 is again provided at the line which connects master brake cylinder 2 to hydraulic modulator 3. This additional brake fluid reservoir 6 has a piston 7 which, in place of the propelling/explosive charge in FIG. 2, has a tension element 8 on the side facing away from the brake fluid. For example, this tension element 8 may be in the form of a spiral spring or a set of several disk springs positioned one on top of the other, but other energy-storing mechanical devices are suitable, as well. This tension element is preloaded, so that piston 7 is under pressure. To prevent tension element 8 from relaxing, retaining bolts 9 are also provided that prevent piston 7 from shifting toward the brake fluid in additional brake fluid reservoir 6 as a result of the force attack of tension element 8. In the event the surrounding-field sensor system has detected a driving situation in which a collision is immediately imminent, the firing lines (flash) fire at least one propelling/explosive charge that may be designed as part of retaining bolts 9. Retaining bolts 9 are thereby destroyed or released, allowing tension element 8 to shift piston 7 toward the brake fluid. A brake fluid pressure thereby results which is transmitted via hydraulic modulator 3 to supply lines 4 leading to the wheel pistons. A non-return valve may be provided at the output of master brake cylinder 2 in this exemplary embodiment as well, in order to prevent a strong movement of brake pedal 1 in the footwell of the passenger compartment in the event the device described is triggered.

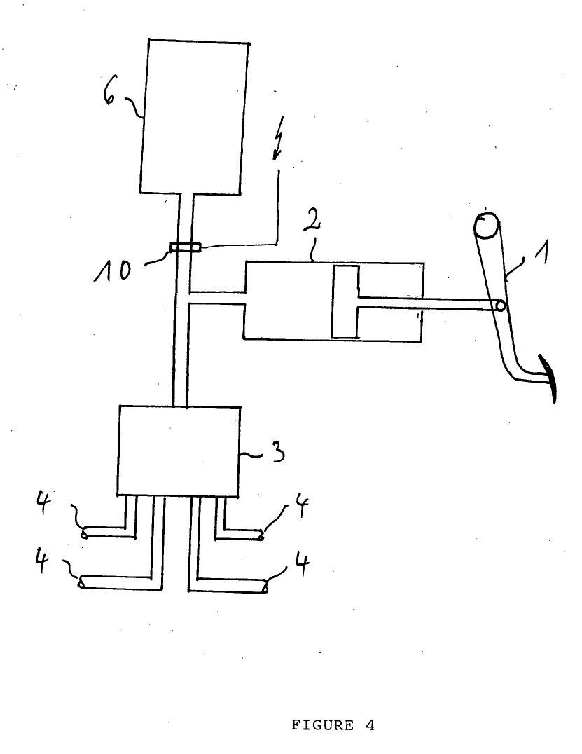

FIG. 4 again portrays a brake pedal 1 that is connected via a linkage to a master brake cylinder 2. In response to actuation of brake pedal 1, the piston in master brake cylinder 2 is displaced, thereby building up a braking pressure that is transmitted via an optionally provided hydraulic modulator 3 of an antilock device to supply lines 4 leading to the wheel pistons of the brake system. A connection to another further brake fluid reservoir 6 is provided at the line between master brake cylinder 2 and hydraulic modulator 3 in this exemplary embodiment, as well. This brake fluid reservoir is under high pressure and is sealed in pressure-tight fashion by pressure seal 10. In the case of the emergency-braking demand, which is called for via a firing line (flash), pressure seal 10 is opened by a propelling/explosive charge, which means the pressure in additional pressure reservoir 6 is able to escape, and pressure is applied to the hydraulic system of the braking device.

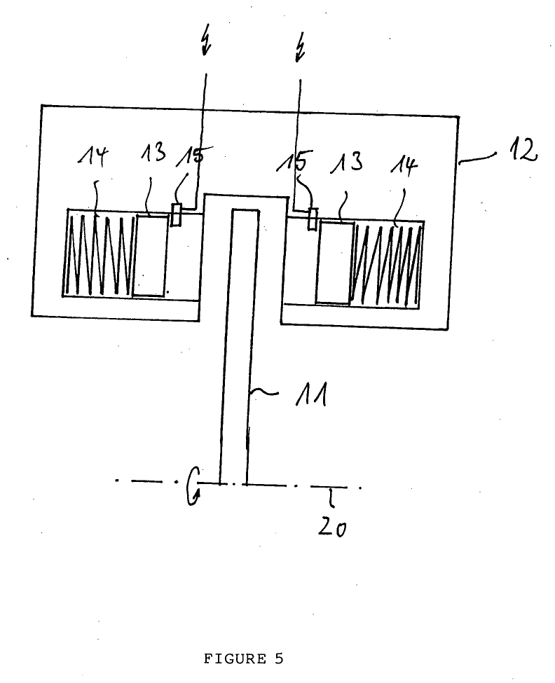

FIG. 5 shows a further device which does not act on the hydraulic braking components, but rather acts directly on the wheel brakes. A part of a schematically depicted brake disk 11 is shown, which rotates about axis of rotation 20 during vehicle operation. Also shown is a brake caliper 12 which, besides the hydraulically controllable brake pads and brake linings with which deceleration is accomplished during normal vehicle operation, has additional brake pistons 13. These additional brake pistons, which may, of course, be equipped with brake linings, are preloaded by tension elements 14, advantageously in the form of spiral springs or disk springs, and arrested by retaining bolts 15. Due to the preloading of tension elements 14, additional brake pistons 13 are pushed in the direction of the brake disk, which is prevented, however, by retaining bolts 15. In the case of an existing collision situation in which an emergency braking is demanded, a firing signal is output via the firing lines (flash), whereby the propelling/explosive charges, which are formed as part of retaining bolts 15, are fired. In this way, retaining bolts 15 are destroyed or released, so that tension elements 14 push brake pistons 13 toward the brake disk, a strong decelerative action thereby commencing.

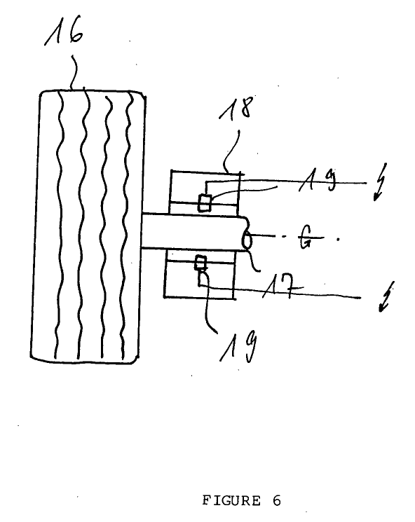

FIG. 6 shows a further exemplary embodiment in which the decelerative action takes place without influence on the hydraulic braking components. A vehicle tire 16 can be seen, which has a wheel axle 17 about which wheel 16 rotates. Wheel axle 17 is supported in a wheel bearing 18, whereby wheel 16 is guided. Propelling charges or explosive charges 19 are provided in wheel bearing 18, which are ignitable in the event of an unavoidable collision of the vehicle. To that end, a firing signal (flash) is generated via firing lines which ignites propelling/explosive charges 19, thereby destroying wheel bearings 18. During normal operation, the wheel bearings have a very small rotational friction, so that the vehicle loses only a little energy as a result of the wheel rotations. By the destruction of wheel bearings 18 as a result of the effect of propelling/explosive charges 19, the rotational friction of wheel bearing 18 is increased enormously, or wheel axle 17 is completely prevented from rotating in wheel bearing 18. In this way, vehicle wheel 16 is strongly decelerated, whereby the greatest possible kinetic energy can be converted into wheel friction prior to the crash.

1-13. (canceled)

14. A device for initiating and implementing a sudden vehicle deceleration, comprising:
at least one of a propelling charge and explosive charge, an explosion of which acts on at least one component of a deceleration device.

15. The device as recited in claim 14, wherein the at least one of the propelling charge and explosive charge act on the at least one component of the deceleration device for an emergency braking situation.

16. The device as recited in claim 14, wherein the at least one of the propelling charge and the explosive charge is configured so that the explosion of the propelling charge and explosive charge moves a piston that applies pressure to brake fluid.

17. The device as recited in claim 14, wherein an arrester is destroyed by the explosion, so that stored energy of an energy-storing apparatus is released.

18. The device as recited in claim 17, wherein the energy-storing apparatus is a brake fluid reservoir under high pressure which causes a pressure build-up in a brake system due to the destruction of the arrester.

19. The device as recited in claim 17, wherein the energy-storing apparatus is at least one of a preloaded spring and a preloaded piston which, by tension release, brings about a pressure build-up in a brake system.

20. The device as recited in claim 17, wherein the arrester is a retaining bolt or a valve.

21. The device as recited in claim 14, wherein the at least one component of the deceleration device on which the at least one of the propelling charge and explosive charge acts is a master brake cylinder.

22. The device as recited in claim 14, wherein the at least one component of the deceleration device on which the at least one of the propelling charge and explosive charge acts is an additional brake cylinder.

23. The device as recited in claim 14, wherein the at least one component of the deceleration devices on which the at least one of the propelling charge and explosive charge acts is an arrester in a brake caliper which, in response to the explosion of the at least one of the propelling charge and explosive charge, releases preloaded, additional brake pistons that act on brake disks.

24. The device as recited in claim 14, wherein the explosion of the at least one of the propelling charge and explosive charge is triggered by a surrounding-field sensor system when an unavoidable collision is detected based on objects in surroundings of the vehicle and movement of the objects.

25. The device as recited in claim 24, wherein the sensor system includes at least one of: i) a radar sensor for adaptive distance and speed measurement, ii) a video sensor, iii) a laser sensor, and iv) an ultrasonic sensor.

26. The device as recited in claim 14, further comprising:
a device configured to reduce pressure in a brake system by opening at least one valve of an antilock braking system after triggering the sudden vehicle deceleration.

27. A device for initiating and implementing a sudden vehicle deceleration, comprising:
at least one of a propelling charge and a explosive charge, an explosion of which acts on at least one wheel bearing, decelerative action being obtained by destruction of the wheel bearing.

28. The device as recited in claim 27, wherein the at least one of the propelling charge and the explosive charge acts on the at least one wheel bearing for an emergency breaking situation.
